(19) United States
(12) Patent Application Publication
(10) Pub. No.: US 2024/0057237 A1
(43) Pub. Date: Feb. 15, 2024

(54) MODULAR LIGHTING SYSTEM

(71) Applicant: SYNETRONICS BAUGRUPPEN AG, Mümliswil (CH)

(72) Inventor: Timmy Kim WYSS, Rheinfelden (CH)

(21) Appl. No.: 18/268,265

(22) PCT Filed: Dec. 17, 2021
(86) PCT No.: PCT/EP2021/086499

§ 371 Date: Jun. 19, 2023

(30) Foreign Application Priority Data
Dec. 22, 2020 (CH) 01655/20

(51) Int. Cl. H05B 47/155; F21S 2/00; H05B 45/20; H05B 47/195

(52) U.S. Cl. CPC H05B 47/155; F21S 2/005; H05B 45/20; H05B 47/195; F21Y 2115/10

(57) ABSTRACT

Disclosed is a lighting system (1) including a number of modules (2). The modules (2) includes a master module (2.1) and a number of slave modules (2.2). The modules (2) each include a mounting interface (3) for mounting on a wall or a ceiling, and a control unit (4). The control unit (4) is in each case configured to store a respective active lighting pattern. The modules (2) each further include a module communication interface and a plurality of lighting elements (6). The master module (2.1) is configured to generate a respective starting command for at least one module (2) and each module (2) is configured to autonomously execute the active lighting pattern of the respective module (2) in response to the respective starting command.

### FIELD OF THE INVENTION

The present invention is in the field of lighting systems and in particular modular lighting systems designed as ceiling light or as a wall-mounted luminaire.

### BACKGROUND OF THE INVENTION

A large variety of lighting systems is known in the art for the purpose of lighting respectively illuminating rooms in homes, hotels, offices and the like. Besides the main purpose of providing a required amount of light, such lighting systems may be designed to illuminate a room in a particular pleasant manner. State of-the art lighting systems may be comparatively complex systems that may include a number of modules and a wide variety of control capabilities, including different modes of operation, control of brightness, color temperature, and the like.

EP3107354A1 shows an arrangement with several light modules. The light modules are connected to a common power supply and can communicate wirelessly or by wire. The complete light control is explicitly integrated in the control unit of each light module. In a stairwell, for example, the lighting modules can respond in a coordinated way and have “swarm intelligence”. A central control program or a central control unit should explicitly not be present.

U.S. Pat. No. 9,078,299B2 shows an intelligent lighting system. In addition to calculation-optimization and simulation components, the system can include a central control system that receives various input signals, e.g. from daylight sensors, timers and weather forecast data, and determines control signals for light dimmers based on these signals. The connection can be either wired or wireless. The control system can be implemented either as a centralized system or as a decentralized and self-organizing system, with each luminaire having its own control system with its own intelligence. The overall control topology can be based on the principle of swarm intelligence.

EP2375867A2 shows a control system (Power Control Device) for LED lamps. It is strongly focused on a specific, easy to implement hardware solution with mandatory wireless control.

### SUMMARY OF THE INVENTION

It is an overall objective of the present disclosure to improve the state of the art regarding lighting systems for rooms, in particular inner rooms of a building. Favorably, the lighting system is comparatively simple in installation and offers a high flexibility regarding the geometrical setup as well as regarding the lighting capabilities. In particular designs, the lighting system may in particular be used in a children's room, but also in other rooms, such as living rooms, offices, or the like. Favorably, the lighting system provides a number of different lighting patterns and/or customizable lighting patterns and is adaptable to varying needs.

In a general manner, the overall objective is achieved by the subject of the independent claims. Exemplary and particular embodiments are further defined by the subject of the dependent claims as well as the overall disclosure.

In an aspect, the overall objective is achieved by a lighting system. The lighting system includes a number of modules. The number of modules includes a master module and a number of slave modules. In a further aspect, the overall objective is achieved by a master module for use in a lighting system according to any embodiment of the present disclosure. In a further aspect, the overall objective is achieved by a slave module for use in a lighting system according to any embodiment of the present disclosure. In a further aspect, the overall objective is achieved by the use of a lighting system, and/or a master module, and/or a slave module according to any embodiment of the present disclosure.

The modules favorably each include a mounting interface for mounting the respective module on a wall or a ceiling. The modules each include a control unit, wherein the control unit is in each case configured to store a respective active lighting pattern of the respective module. The modules further each include a module communication interface in operative coupling with the control unit of the respective module. The modules further each include a plurality of lighting elements in operative coupling with the control unit of the respective module.

The master module further includes a power supply unit, wherein the power supply unit is configured to be connected to an external electric power supply. The power supply unit further includes a power distribution interface. The number of slave modules each include a power receiving interface configured to electrically connected to the power distribution interface. Via the power distribution interface of the master module and the power receiving interfaces of the slave modules, the slave modules are supplied with electric power. The power supply unit may include an input supply connector, the input supply connector being configured to be connected, in particular permanently connected, to an external electric power supply. In a preferred embodiment, the external power supply is a general building power supply, in particular a line voltage supply, such as a 230 VAC and/or 110 VAC line voltage supply.

In an embodiment, the power supply unit includes a central mains adapter that is configured to transform the power as provided by the external power supply for use by the modules as generally known in the art and may include a transformer, rectifier, smoothening capacitors and the like. In such embodiment, an output side of the central mains adapter is connected to the power distribution interface and the slave modules are accordingly powered via the power distribution interface and the power receiving interface of the respective module by the central mains adapter. Further in such embodiments, the slave modules do not include separate mains adapters. For this type of embodiment, all modules, i.e. the master module as well as the slave module, are in operation powered by the central mains adapter. In alternative embodiments, the power distribution interface is configured to be directly electrically connected to the external power supply, respectively, the power supply interface is directly connected to the input supply connector without a central mains adapter. In such embodiment, each of the modules receives electric power as provided by the external power supply, in particular line voltage. In such embodiment, the modules, i.e. the master module as well as the slave modules, each include a separate local mains adapter.

It is noted that the power supply of the slave modules via the power distribution interface of the master module and the power receiving interfaces of the slave modules does generally not directly match the operation voltage of the lighting elements and/or circuitry of the slave modules, but may have a different voltage, in particular a higher, and may, for example also be an AC voltage. Therefore, the modules and in particular the slave modules generally include corresponding power interface circuitry that provides the required operational voltage or voltages for the lighting elements as well as general circuitry of the respective module. Such power interface circuitry may, for example, be part of the control unit of the respective device. In embodiments with a local mains adapter in each module, it may also be part of the respective local mains adapter.

The master module is further configured to generate a respective starting command for at least one module. Each module is further configured to autonomously execute the active lighting pattern of the respective module in response to the respective starting command. Each module accordingly executes its respective active lighting pattern upon receiving its starting command. The starting command that may be generated by the master module may in particular be or include an initial starting command for switching the lighting system from a switched-off state where no module executes its respective active lighting pattern into a switched-on-state where one or more modules execute their respective active lighting pattern. The lighting system is switched on via the initial starting command. The master module may in particular be configured to generate the initial starting command in response to a corresponding user input respectively user action. In the switched-on state, the lighting system is also referred to as being activated and in the switched-off state the lighting system is also referred to as being deactivated. In an embodiment, the control unit of the master module is further configured to generate a stopping command, for example a global stopping command, for switching the lighting system from the switched-on state into the switched-off state as also discussed further below. Typically, a stopping command may be generated in response to a corresponding user input respectively user action.

The master module further includes a local user interface in operative coupling with the control unit of the master module and/or the control unit of the master module is configured for operatively coupling with a remote control device. A remote control device provides a remote user interface as explained further below in more detail.

Generally, a user interface includes one or more input elements, such as keys, touch buttons, push buttons, and the like, and/or one or more output elements, such as indicator LEDs and/or a display. A user interface may in in some embodiments particular include a touch screen. The expression “local user interface” refers to a user interface that is structurally integrated into the master module respectively forms an integral part of the master module. Where not explicitly referred to as “remote user interface” or “local user interface”, the expression “user interface” may generally refer to any of them.

Via a user interface, the control unit of the master module may be controlled to generate an initial starting command as mentioned before. Further, the user interface may be configured to receive lighting pattern input provided by a user, the lighting pattern input defining at least one user-defined lighting pattern. Further in some embodiments, a user interface may be configured to a receive selection input, the selection input selecting an active lighting pattern from a number of available lighting patterns as discussed below.

For communicating with a remote control device, the master module may include a remote control device communication interface, in particular a wireless remote control device communication interface, which is part of or operatively coupled with the control unit of the master module. By way of example, the remote control device communication interface may be designed, for example, for communication via infrared, Bluetooth, WLAN, Zig Bee and/or any other communication technology and protocol as generally known in the art, and/or according to proprietary communication protocol. A remote user interface may, for example, be or include a wireless light switch and/or dimmer as generally known in the art in order to start and stop room illumination by the lighting system and/or adjusting the lighting brightness. Further, a remote user interface may be provided on a general-purpose device, such as a smart phone, a tablet computer, a laptop computer PC, or the like, which is configured for coupling, in particular wirelessly coupling, with the remote control device communication interface. Such type of remote user interface has the advantage of providing a comfortable user interface for more complex actions, such as defining or programming user-defined lighting patterns, selecting active lighting patterns from a number of available lighting patterns as explained further below, and the like. To serve as user interface of the lighting system, a general-purpose device may run a corresponding software code respectively application. Alternatively, or additionally, the control unit of the master module includes an integrated web server that is configured to provide, via the remote control device communication interface, the user interface on a web browser of a general-purpose device.

It is noted that more than one remote user interface may be present in a particular configuration, optionally connected in addition to a local user interface, and different remote user interfaces may offer different functionality. By way of example, a simple wireless light switch may be present for switching on and off the lighting, in the same manner as a conventional light. Switching the lighting system on and off may additionally be done for example via a general-purpose device which further offers additional functionality.

A user interface may further be used for controlling, in particular switching on and off, one or more spot lighting elements and/or edge lighting elements as explained further below.

The slave modules do generally not comprise own user interfaces and/or user interface communication interfaces. Communication with a slave module is generally done by respectively via the master module and the module communication interfaces.

The modules are structurally separate and distinct. However, as explained further below, they are generally arranged in a side-by-side arrangement and coupled to each other in a mounted respectively operational configuration. Generally, a single master module and a plurality of slave modules is present. Where not specified, for example as “master module” or “slave module”, the expression “module” generally refers to any module, being it the master module or a slave module.

The lighting elements of each module are generally arranged at the front of the respective module. The front of each module faces the room in which the lighting system is installed, respectively away from the wall or ceiling at which the modules are installed. A contour of a module when viewing, generally in a perpendicular manner, onto its front form the outside of the module (respectively from within the room in which the lighting system is installed) is referred to as footprint of the module. The direction transverse to the footprint is referred to as thickness direction and the dimension of a module in this direction is referred to as thickness. The dimensions transverse to the thickness direction respectively the dimensions in a plane of the footprint are referred to as lateral dimension. The thickness direction is generally also essentially perpendicular to a wall or ceiling at which the modules are mounted and the lateral dimensions are parallel respectively tangential to the wall or ceiling. Favorably, the overall shape of the modules is disk-shaped, e.g. the thickness is considerably smaller than the lateral dimensions. In a typical design, the thickness of the modules is between 20 mm and 100 mm, favorably between 20 mm and 30 mm, while the footprint is square and has an edge length of 500 mm. Favorably, the thickness is identical for all modules. The front of each module is generally given by a room-facing-side of a front wall (also referred to as front panel) of the respective module. A circumferential wall of each module favorably projects from a circumferential edge of the side in the thickness direction. The circumferential wall generally projects perpendicularly from the front wall the respective module and/or from a wall or ceiling at which the module is mounted. In a mounted state, the modules may contact the wall or ceiling with their whole surface area (in case of the side of the modules facing the wall or ceiling being planar), via distance pieces or spacers, or along the circumferential wall. While a generally closed circumferential wall is favorable, some or all sides of a module may in principle have openings or be open and/or structured as desired. A side of a module refers to a view, generally in perpendicular manner, on the circumference respectively a circumferential wall of a module respectively a section thereof. In typical designs where the front and the footprint have the shape of a polygon, e.g. a square, rectangle or hexagon, the circumference respectively a circumferential wall has a corresponding number of sides or segments.

In an embodiment, the modules have in each case a substantially flat or planar front. In such embodiment, the front of the modules is generally parallel to a wall or ceiling at which the lighting system is installed and spaced apart therefrom by the thickness of the modules.

A front wall the modules may have openings or apertures that correspond to the pattern of the lighting elements, with the lighting elements being each arranged in or aligned with the respective opening. In a particularly favorable embodiment, however, the front wall is made from a transparent or translucent material, e.g. glass, and the lighting elements are arranged within the module and light through the front wall. If desired, an in principle transparent front wall may also be partly in-transparent or opaque, thereby forming a field stop for some or all lighting elements. By way of example, the front wall may be opaque respectively non-transparent over most of its surface area and only have transparent sections in those areas where lighting elements are arranged. Such transparent sections may have any desired shape, for example, oval, circular or star shaped, that appear as illuminated if the respective lighting element is activated. If appropriate, a corresponding field stop may also be arranged between the lighting elements and the front wall.

The plurality of lighting elements of a module is generally arranged in a pattern and laterally distributed over the respective module respectively its front. The lighting elements of a single module may be of the same or different types. Typically, the lighting elements include a plurality of light emitting diodes (LEDs), favorably 4-color LEDs. The control unit of each module is generally configured to individually control the single lighting elements and the single colors of each lighting element (It is noted that a 4-color LED generally consists of 4 LEDs having the colors red, green, blue, white. For the purpose of the present document, however, they are considered in combination as one lighting element).

Typically, each module includes a separate mounting interface, thereby allowing the respective module to be mounted on and supported/carried by a wall or ceiling. It is noted that alternatively to a wall or ceiling, a module may generally be mounted on any other substantially even respectively planar surface. As explained further below, however, in an assembled configuration with a plurality of modules, not each and every module needs to be necessarily individually mounted to the wall or ceiling. Instead, only part of the modules may be directly mounted to the wall of ceiling, with the other modules being supported by those modules that are directly mounted to the wall or ceiling. The mounting interface may for example include or be realized by a tubular element that may be arranged at or near the geometrical center of the footprint and extend along the thickness direction, thereby allowing a mounting of the respective module via a screw or the like that extends through the tubular element. It is noted, however, that other mounting and/or fixation arrangements may also be foreseen.

The control unit of each module is generally a semiconductor-based circuitry that typically includes one or more programmable components, such as microcontrollers running a corresponding code, and/or dedicated circuitry. Further, the control unit generally includes the interface and driver circuitry that is required for controlling and driving the lighting elements of the respective module. Further, other functional units of the module, for example the module communication interface, may be realized with the control unit in an integral manner. The control unit and optionally further electronic components may, for example be mounted on a Printed Circuit Board (PCB) or on a number of interconnected PCBs.

The module communication interface of each module is configured for communication respective data exchange with further modules, that is, it serves the purpose of inter-module communication. Typically, the module communication interface of each module is configured for communicating respectively exchanging data with each further module. The module communication interface of each module may be wired or wireless. Further aspects of particular embodiments of the module communication interface are discussed further below. Starting commands and stopping commands as well as any further data and information is exchanged between the modules are exchanged via the module communication interfaces of the respective modules. Correspondingly, the module communication interfaces are generally configured for bidirectional communication.

For wired communication interfaces, the communication interface of each module may include a number of dedicated communication interface connectors. Such communication interface connectors may in particular be arranged at different sides of each module in the same manner as discussed further below in the context of power distribution interface connectors and power receiving interface connectors.

In an embodiment, the module communication interface of the master module is integral with the power distribution interface and the module communication interface of each slave module is integral with the power receiving interface of the respective slave module. In such embodiment, the electric connection for the power supply respectively power distribution is also used for data exchange and no separate physical interface respectively connectors are required. In such embodiment, the electric power supply may be modulated respectively modified for transmitting data as generally known in the art.

In an embodiment, the power distribution interface of the master module includes a number of power distribution interface connectors, in particular a number of power distribution interface connectors arranged at different sides of the master module, wherein the power distribution interface connectors are each configured for simultaneous coupling with the power receiving interface of a different respective slave module. The power distribution interface connectors are generally electrically connected with each other. The power distribution interface connectors may be arranged in a circumferential wall of the master module as explained before.

In an embodiment, the power receiving interface of at least a number of slave modules each include a number of power receiving interface connectors, in particular a number of power receiving interface connectors arranged at different sides of the respective slave module. The power distribution interface connectors may be arranged in a circumferential wall of the respective slave module as explained before. The power receiving interface connectors are each configured for alternative coupling with the power distribution interface, in particular a power distribution interface connector, or a power receiving interface connector of a further slave module. In a particular embodiment, all slave modules are designed in this manner. The power receiving interface connectors of a slave module are generally electrically connected with each other.

The power distribution interface connectors and the power receiving interface connectors may in particular be or include plug and/or socket connectors. Providing power distribution interface connectors at different sides of the master module allows to directly provide electrical power to a respective number of slave modules. Further by providing power receiving interface connectors at different sides of slave modules allows connecting a slave module with the master module in different orientations. Further, the power receiving interface of the slave modules may each be configured for coupling with the power receiving interface of a further slave module. Specifically, the power receiving interface connectors of the slave modules may each be configured for coupling with a power receiving interface connector of a further slave module. This kind of design allows indirectly powering slave modules via other slave modules. With other words, the power receiving interface of a slave module may at the same time provide electrical power to one or more further slave modules and the power supply is accordingly wired through to a specific slave module from the master module via one or more intermediate slave modules. The power supply of a slave module by the master module may accordingly be direct if the power receiving interface of the respective slave module is directly connected to a power distribution interface of the master module. This is generally the case for slave modules that are arranged adjacent to the master module. Alternatively, the power supply of a slave module by the master module may be indirect if the power receiving interface of the respective slave module receives electrical power via a power receiving interface of another slave module, in particular adjacent slave module.

Providing power distribution interface connectors and power receiving interface connectors at different sides, favorably all sides of the master module and slave modules respectively, allows a side-by-side-arrangement of a number of modules without requiring cabling respectively wiring among the modules.

In an embodiment, the power distribution interface connectors and the power receiving interface connectors are in each case arranged to be flush with a side surface respectively the circumferential wall respectively stand back behind the side surfaces. Where an electrical connection shall be established between adjacent modules, a corresponding intermediate connector element may be provided to couple the respective connectors. In this way, no projecting elements are in any case present which is particularly favorable for modules that are not surrounded by adjacent modules on all sides. Further all power distribution interface connectors and power receiving interface connectors are favorably of identical design. As explained before, the power distribution interface and accordingly the power distribution interface connectors of the master module as well as the power receiving interfaces and accordingly the power receiving interface connectors of the slave modules may either be designed for line voltage if each module includes a separate local mains adapter or be designed in accordance with the output of a central mains adapter of the master module.

It is noted that one or more slave modules may be provided with electrical power via a dedicated wiring or cabling that is connected to its power receiving interface, in particular a power receiving interface connector as mentioned before. This is the case if a module or group of modules may not be arranged separately e.g. due to constraints, such as beams. In this case, the modules may for example be arranged in two groups that are separated by the beam, with either of the groups comprising the master module. In such case, the beam may be bridged by a cabling or wiring. The same may apply to module communication interfaces.

In an embodiment, the modules each include a number of module interconnection interfaces. The module interconnection interfaces area each configured to mechanically interconnect the respective module with an adjacent module. Generally, each module interconnection interface is configured to mechanically interconnect the respective module with one adjacent module in a one-to-one manner. The module interconnection interfaces of each module are favorable arranged at or in the circumferential wall of each module as explained before. For modules that allow tessellation of a wall or ceiling as discussed further below, a module interconnection interface may be arranged in the circumferential wall at each side of a module where an adjacent module may be arranged. In particular, for the modules having a square or rectangular footprint, a module interconnection interface may be arranged at each of the four sides.

A module interconnection interface may in an embodiment include a number of, e.g. two receptacles, for example bores in a side surface respectively the circumferential wall of the respective module. In a mounted configuration, each of the receptacles is aligned with a corresponding receptacle of an adjacent module. Adjacent modules may be connected via connection elements, e.g. bolts, that are partly inserted into the aligned receptacles of the adjacent modules. The module interconnection interfaces as well as the connection elements are favorably designed and dimensioned to absorb bending forces. In this manner, not each and every module needs to be separately mounted to the wall or ceiling as mentioned before, but some modules may be supported by neighboring respectively adjacent modules. By way of example, it may be sufficient to directly mount every second module in a line of modules to the wall or ceiling. If appropriate, the module interconnection interfaces may include a mechanical locking mechanism.

In an embodiment, the modules each have a footprint, in particular an identical footprint, that enables tessellation of a wall or ceiling by the number of modules. In a particular embodiment, the modules each have a footprint corresponding to an equilateral triangle, a rectangle, a square, or a regular hexagon. A footprint that enables tessellation is favorable from a design and aesthetic point of view since it allows to arrange the modules such that their respective fronts form, in combination, a common and uninterrupted front of the lighting system. It is noted that the mentioned exemplary footprints are not essential. Instead, other and more complex footprint geometries may be used that are known, for example, for tiles.

In a typical embodiment, each side of a module that includes a module interconnection interface also includes a power distribution interface connector in case of the master module respectively a power interface receiving connector in case of a slave module. Further, each such side favorably includes a communication interface connector in embodiments where separate communication interface connectors are foreseen.

The expression “lighting pattern” refers to the control of the lighting elements of a specific module as function of time. A lighting pattern may include information regarding activating/deactivating (i.e. switching on and off) of lighting elements, brightness, and color temperature (as determined by the control of the single LEDs of a 4-color-LED as mentioned before). The expressions “storing”, “transmitting” or “receiving” are in the context of lighting patterns to be understood as storing, transmitting or receiving the respective control information and/or control parameters. Examples for lighting patterns are, for example, blinking patterns, random patterns (including either of both of brightness and color temperature), pattern with ascending and descending brightness, or running light patterns.

A lighting pattern may be an endless lighting pattern. An endless lighting pattern is, once started, executed in a continuous or endless manner until it is explicitly stopped, e.g. via a corresponding stopping command. Alternatively, a lighting pattern may be a single-execution lighting pattern. A single-execution lighting pattern is a lighting pattern that is, in response to a respective starting command, executed once only and is executed again only upon a new respective starting command.

A lighting pattern may be a pre-defined and pre-stored lighting pattern that is readily provided along with the modules. Alternatively, or additionally, a lighting pattern may be a user-defined lighting pattern that is inputted via a user interface and/or a remotely generated lighting pattern that is received from a remote device via a remote device communication interface as explained below.

In accordance with the present disclosure, each module is configured to store at least a respective active lighting pattern and to autonomously execute the respective active lighting pattern upon reception of a respective starting command. In this way, only a minimum amount of inter-module communication is required in operation of the lighting system, largely independent of the total number of lighting modules and the complexity of the individual lighting patterns. The expression “autonomous execution” refers to each lighting module not requiring further data for executing the respective active lighting pattern. The active lighting pattern that is stored by the control unit of each module may be identical or different for some or all modules.

Lighting of a room is started by the master module generating a starting command, in particular of an initial starting command as mentioned before, for at least one module, upon which the respective module executes its active lighting sequence. Optionally, the master module may generate respective starting commands for some or all modules at the same point in time and/or with a relative time delay. It is noted that, regarding the execution of lighting patterns in general and in particular the respective active lighting pattern, the master module is configured to act in the same manner as the slave modules. Correspondingly, the master module is configured to execute its active lighting pattern in response to a respective starting command. Such a starting command for the master module may be generated by the control unit of the master module. As discussed further below in more detail, however, also slave modules respectively their control units may be configured to generate starting commands for further slave modules as well as the master module.

In an embodiment, the master module is further configured to generate a stopping command. Such stopping command may either be a dedicated stopping command for a particular module or a number of modules, or a global stopping command for all modules. In response to a respective stopping command, a module stops respectively terminates execution of its respective active lighting pattern. A stopping command, in particular a global stopping command, may in particular be used for ending the lighting of a room in which the lighting system is installed.

In a particular embodiment with a local user interface, the local user interface is arranged movably, in particular pivotable movably, between a fold-out configuration and a fold-in configuration. The user interface projects from a front of the master module in the fold-out configuration and is flush with the front of the master module in the fold-in configuration.

Such a movably arranged local user interface is favorable regarding both space consumption and design/aesthetics. In the fold-in configuration, the local user interface simply forms a part of the front of the master module and may virtually “disappear”. In the fold-out configuration, such local user interface provides sufficient space for all desired input/output elements, such as a display, keys and/or a touch screen.

In dependence of the pattern in which the lighting elements are arranged, one or more lighting elements of the master module may be integrated into the local user interface.

Those lighting elements are visible together with the other lighting elements of the master module in the fold-in configuration.

In an alternative embodiment, a local user interface is integrated into the master module in a non-movable manner. In this embodiment, the user interface may be set back with respect to front of the master module and the front wall of the master module is itself arranged pivotable or removable, e.g. via a user-operable snap-in or click-in connection. If the front wall is removed respectively pivoted away from a body of the master module, the local user interface is accordingly accessible, while it is hidden and optically disappears otherwise.

In an embodiment, the master module includes a remote device communication interface. The master module may be configured to receive at least one lighting pattern via the remote device communication interface. Such remotely generated lighting patterns may serve as active lighting pattern and/or available lighting pattern as explained further below. The remote device communication interface may be part of or operatively coupled with the control unit of the master module.

A remote device communication interface may be separate from or integral and/or identical with a remote control device communication interface as explained before. Via the remote device communication interface, new lighting patterns may be transferred to the lighting system in a convenient manner. The remote device communication interface may, for example, be or include the WLAN and/or LAN interface. In this way, a lighting pattern may, for example, be purchased from the supplier of the lighting system and be directly transmitted to the lighting system by the supplier as remotely generated lighting pattern.

In an embodiment, the master module includes a number of sensors, wherein the sensors are each configured for providing a respective sensor signal in dependence of at least one environmental parameter. The master module may be configured to control operation the lighting elements of at least one module of the number of modules in dependence of the number of sensor signals.

Such sensor may include, for example, room climate sensors, such as a room temperature sensor, a humidity sensor, and further, for example, an oxygen sensor and/or carbohydrate sensor, and/or a photo sensor respectively light sensor. Controlling operation of lighting elements in dependence of such sensor signals allows an additional use of the lighting system for monitoring and indicating relevant environmental conditions. The control unit of the master module may in particular be configured to continuously or repeatedly compare one or more sensor signals with respective threshold values and control lighting elements to provide an optical alert or warning in case a threshold value is exceeded. The master module may further be configured to transmit information as determined by the one or more sensors, such as measurement values, alerts and/or warnings, to a remote device, for example a smart phone.

Controlling of lighting elements in dependence of sensor signals as well as the providing of alerts or warnings in dependence of sensor signals may favorably configured, parametrized and/or activated or deactivated via a user interface and/or via a remote device as mentioned before. Further, one or more sensors, in particular a light sensor, may control the switching on and off of edge lighting elements as explained further below. In further embodiments, one or more sensors as explained before may be arranged in the slave modules.

In an embodiment, the modules are each configured to store a number of respective available lighting patterns. The master module may be configured to generate a respective selection command for each module. Each module is configured to select either of the respective available lighting patterns as respective active lighting pattern in in response to the respective selection command.

The modules each storing a number of available lighting patterns allows a flexible use and change of lighting patterns in a convenient manner with minimum communication effort between the modules. Such available lighting patterns may be pre-installed, may be user-defined lighting patterns and/or be remotely generated lighting patterns. In typical embodiments, all modules store the same available lighting patterns. Alternatively, however, different modules may store different available lighting patterns.

In an embodiment, the lighting system is configured for transmitting lighting patterns from the master module to the number of slave modules. Lighting patterns may favorably be transmitted via the module communication interfaces of the master module and the slave modules. A transmitted lighting pattern may, for example, be a user-defined lighting pattern that is inputted via a user interface, or a remotely generated lighting pattern. In way, lighting patterns may be distributed from the master module the slave modules. The lighting system may be configured for distributing lighting patterns to a particular slave module, a number of slave modules, or all slave modules.

In embodiments where the slave modules are not configured to each store a number of available lighting patterns but only a single lighting pattern, namely the respective active lighting pattern, transmitting lighting patterns from the master module to slave modules enables the change of lighting patterns.

In an embodiment, the slave modules are each configured to generate a respective starting command for at least one further module. Generally, the at least one further module may be any module or group of modules, including the master module. This kind of embodiment is particularly favorable in the context of meta lighting patterns as explained in the following. A meta lighting pattern is a lighting pattern that is executed simultaneously or sequentially by a number of different modules. Typically, the active lighting patterns are single-execution lighting patterns. By way of example, a single-execution lighting pattern that is executed by a module as active lighting pattern may be a running light lighting pattern that includes sequentially controlling the lighting elements of the respective module such that a running light moves from one end, e.g. a left end, of the module to an opposite end, e.g. a right end of the respective module. Assuming a number of modules that are arranged in a row, a corresponding running light meta lighting pattern may include a running light moving from the left side of the leftist module to the right side of the rightest module. To execute such running light meta lighting pattern in a coordinated and synchronized manner, each module may, upon the execution of its running light lighting pattern being completed, generate a starting command for its respective neighboring module to the right. By the rightest module generating a starting command for the leftist module, the running light meta lighting pattern may be executed as endless lighting pattern respectively in an endless manner, while being composed of executions of single-execution lighting patterns by the individual modules. The meta lighting pattern may and typically is accordingly an endless lighting pattern, while the active lighting patterns of the individual modules are, as such, single-execution lighting patterns. Favorably, the execution of its active lighting pattern by the master module may be also be started via a starting command that is generated by a slave module.

A slave module may be configured to generate a starting command for one, a plurality, or all further modules. Generally, a starting command may be generated by a module in dependence of the execution of the active lighting pattern of the respective module, in particular at a specific point in time of the execution of the active lighting pattern by the respective module. The point in time or a number of points in time where starting commands are generated for at least one further module may form part of a lighting pattern.

In an embodiment, each module is configured to store a respective unique module identifier and to transmit the respective unique module identifier to at least one further module of the number of modules. Unique module identifiers are favorable for exchanging information between selected modules, for example in the transmission of starting and/or stopping commands or transmitting lighting patterns as explained before.

In an embodiment, the control unit of the master module is configured to store an arrangement map, the arrangement map reflecting a position of each module with respect to each other module. A local user interface and/or a remote user interface as explained before may be configured for inputting the arrangement map, for example via a touch screen, and/or an arrangement map may be received from another remote device as explained before. The single modules may be identified for example via their respective module identifiers as explained before. An arrangement map is favorable in particular in the execution of meta lighting patterns as explained before. In a particularly favorable embodiment, the master module is configured to transmit the arrangement map to each of the slave modules and the slave modules are each configured to receive and store the arrangement map. Given a meta lighting pattern, the lighting system may be configured to automatically determine the timing of the starting commands for each module based on the position of the modules respectively their positional relationship.

Optionally, one, some, or all modules may further include a spot lighting element that may be arranged, for example, in a central area of the respective module. Such spot lighting element may be more powerful than the further lighting elements. Spot lighting elements are particularly useful to provide additional lighting to a room on demand. In embodiments where one, some, or all modules include a spot lighting element, such spot lighting elements may be switched on and off individually and/or in combination via a user interface. In an embodiment, switching on and off spotlights is only possible in the switched-on state of the lighting system as explained before. In alternative embodiments, however, switching on and off spot lighting elements is independent from the operational state of the lighting system.

Further optionally, modules may include one or more edge lighting elements. An edge lighting element may be provided along an edge of a module, in particular an edge at the front of the respective module and illuminate respectively light the edge. Edge lighting elements are favorably provided at free edges of outermost modules in a mounted configuration. In dependence of a specific pattern in which the number of modules is arranged, edge lighting elements may be provided along one or more edges. Edge lighting elements may be activated and deactivated respectively switched on and switched off similar to spot lighting elements and independent from the execution of lighting patterns. Further, edge lighting elements may be switched on and off in a time-controlled manner and/or be controlled via one or more sensors, for example a light sensor.

### BRIEF DESCRIPTION OF THE DRAWINGS

FIG. 1 shows a schematic view of an embodiment of a lighting system;

FIG. 2 shows a block diagram of an embodiment of a master module;

FIG. 3. shows a block diagram of an embodiment of a slave module;

FIG. 4 shows a schematic front view of an embodiment of a module;

FIG. 5 shows an exemplary arrangement of a master module and a number of slave modules in a schematic view;

FIG. 6 shows a further exemplary arrangement of a master module and a number of slave modules in a schematic view;

FIG. 7 shows a further exemplary arrangement of a master module and a number of slave modules in a schematic view;

FIG. 8 shows a schematic view of a master module in the fold out configuration according to the disclosure;

FIG. 9 shows a schematic view of a slave module according to the disclosure;

FIG. 10 shows a schematic exploded view of the master module according to FIG. 8.

### DESCRIPTION OF THE EMBODIMENTS

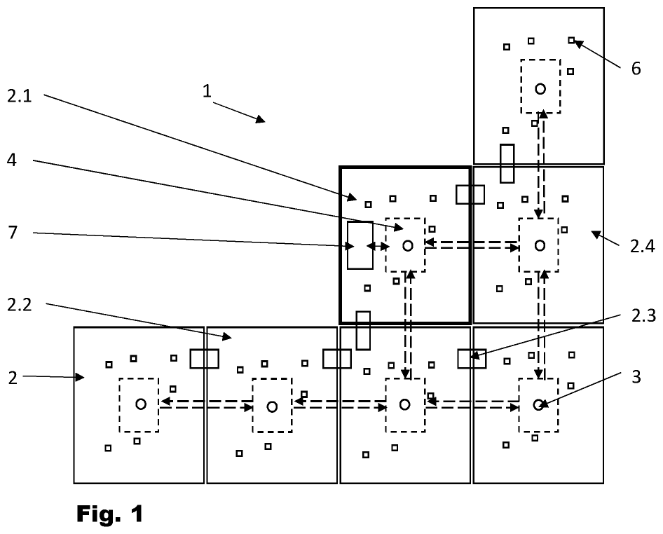

FIG. 1 shows a schematic view of a lighting system 1 including a number of modules 2 in an exemplary arrangement. The shown arrangement includes one master module 2.1 and six slave modules 2.2. This arrangement is chosen for illustration purposes only. Any customized arrangement or pattern and any number of modules 2 is possible. The shown modules 2 each include a mounting interface 3 which is configured for mounting the respective module 2 on a wall or a ceiling. The modules 2 each further include a control unit 4 which is configured according to any embodiment as disclosed in the general description before. The shown modules 2 further each include a plurality of lighting elements 6 in operative coupling with the control unit 4 of the respective module 2, with the lighting elements 6 being realized as 4-color-LEDs. The master module 2.1 includes a power supply unit 7 which is configured to be connected to an external electric power supply, in particular a line voltage supply. The shown modules 2 are structurally separate and distinct. They are arranged in a side-by-side arrangement and coupled to each other in a mounted respectively operational configuration. The modules 2 are interconnected to each other to form the shown arrangement by a number of mechanical module interconnection interfaces 2.3 which are configured to mechanically interconnect the respective module 2 with an adjacent module 2. The power supply unit 7 master module 2.1 further includes a power distribution interface with four power distribution interface connectors at its four sides. Further, the slave modules 2.2 each include a power receiving interface with four power receiving interface connectors at the four side. Each power receiving interface connector is configured for coupling with a power distribution interface connector of the master module 2.1 if the respective salve module 2.2 is adjacent to the master module, or alternatively to a power receiving interface connector of an adjacent slave module. It is noted that in the shown configuration only two of the four power distribution interface connectors are in each case coupled to a power receiving interface connector an adjacent salve module 2.2 (namely to the right and to the bottom of master module 2.1), while the power distribution interface connectors at the left and top side remain unconnected in the shown configuration. Similarly, the power receiving interface connectors at free sides of master modules 2.2 remain unconnected.

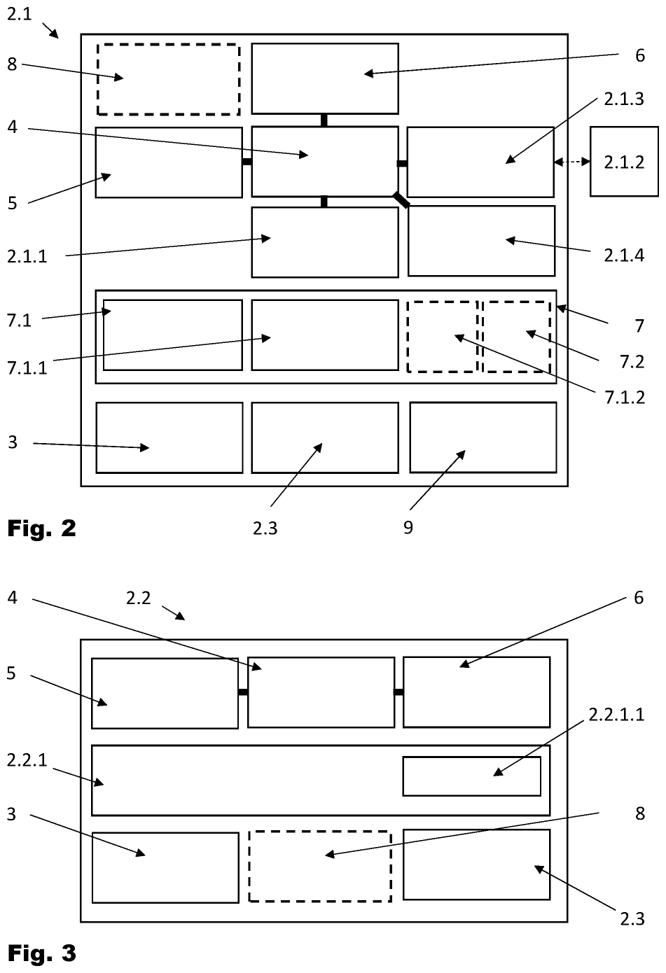

FIGS. 2 and 3 show a block diagram of an embodiment of a master module 2.1, FIG. 2 and a slave module 2.2, FIG. 3 according to the disclosure. Bay way of example, the master module 2.1 and the slave modules 2.2 of FIG. 1 may be designed according to FIG. 2 and FIG. 3.

The shown modules 2.1, 2.2 each include a mounting interface 3 for mounting the respective module 2 on a wall or a ceiling. Further, the master module 2.1 as well as the slave module 2.2 each include a respective control unit 4, with the control unit 4 of the master module 2.1 however being configured to operate differently and provide further functionality as compared to the control unit 4 of the slave module 2.2 and as explained before in the general description. The modules 2.1, 2.2 further each include a module communication interface 5 which is operatively coupled with the control unit 4 of the respective module. The module communication interfaces 5 may be dedicated wired communication interfaces with corresponding connectors, may be wireless communication interfaces or be integral with the power supply and power distribution as explained above in the general description as well as further below. The modules 2.1, 2.2 further each include a plurality of lighting elements 6 which are operatively coupled to and controlled by the control unit 4 of the respective module.

The master module 2.1 further includes a power supply unit 7 which is configured to be connected to an external electric power supply and includes an input supply connector 7.2. The input supply connector 7.2 may generally be designed in the same way as known for wall-or ceiling mountable lamps or lighting systems and include, e.g. screw terminals for electrically coupling to the line voltage supply. The shown power supply unit 7 includes a power distribution interface 7.1 and the slave module 2.2 includes a power receiving interface 2.2.1. The power receiving interface 2.2.1 of the slave module 2.2 includes a number of power receiving interface connectors 2.2.1.1 which are configured for alternative coupling with the power distribution interface 7.1, in particular a power distribution interface connector 7.1.1 of the master module 2.1, or a power receiving interface connector 2.2.1.1 of a further slave module.

Depending on the embodiment, the power supply unit 7 includes either a central mains adapter 7.1.2 which is configured to transform respectively convert the line voltage for use by the modules 2.1, 2.2 as generally known in the art. The central mains adapter 7.1.2 may in particular provide at its output side a lower voltage of e.g. 12 V or 24 V either as AC or DV voltage. In such embodiment, an output side of the central mains adapter 7.1.2 is connected to the power distribution interface 7.1. The central mains adapter 7.1.2 of such embodiment is configured and dimensioned for powering the master module 2.1 as well as the slave modules 2.2. In such embodiment, the power distribution interface 7.1 and accordingly the power distribution interface connectors 7.1.1 of the master module 2.1 as well as the power receiving interfaces 2.2.1 and accordingly the power receiving interface connectors 2.2.1.1 of the slave modules 2.2 are designed in accordance with the output of the central mains adapter 7.1.2 of the master module 2.1.

Alternatively, the power distribution interface 7.1 is directly electrically connected to the external power supply and each of the modules are supplied with electrical power as provided by the external power supply respective line voltage power supply. For such embodiment, the master module 2.1 as well as the slave modules 2.2. include a separate local mains adapter 8. Such local mains adapter 8 may be designed in the same manner as explained before in the context of a central mains adapter 7.1.2, but is generally configured and dimensioned for only powering the respective module 2.1, 2.2. In such embodiment, the power distribution interface 7.1 and accordingly the power distribution interface connectors 7.1.1 of the master module 2.1 as well as the power receiving interfaces 2.2.1 and accordingly the power receiving interface connectors 2.2.1.1 of the slave modules 2.2 are designed for line voltage.

The master module 2.1 further includes a local user interface 2.1.1 in operative coupling with the control unit 4 of the master module 2.1. In the shown embodiment, the control unit 4 of the master module 2.1 is also configured for operatively coupling with a remote user interface 2.1.2 via the local user interface 2.1.1 and/or the remote user interface 2.1.2. The control unit 4 of the master module 2.1 may be controlled to generate an initial starting command, thereby switching the lighting system 1 on and off respectively switching between an activated state and deactivated state of the lighting system, programming respectively inputting new lighting patterns, selecting active lighting patterns from a number of available lighting patterns, and the like. In the shown embodiment, the master module 2.1 also includes an optional remote device communication interface 2.1.4, for example for receiving lighting patterns from a remote device, e.g. a server, and/or receiving firmware respectively software updates, and the like.

For communicating with the remote user interface 2.1.2, the master module 2.1 includes a remote control device communication interface 2.1.3, which can be designed as a wireless remote control device communication interface 2.1.3, which is operatively coupled with the control unit 4 of the master module 2.1 and may include, for example one or more of a Bluetooth interface, a WLAN interface, and/or a Zig Bee interface. The remote device communication interface 2.1.4 may be separate from the remote control device communication interface 2.1.3 or may be partly or fully integral with the same, that is, one and the same interface may serve as both remote control device communication interface 2.1.3 and remote device communication interface 2.1.4.

The module communication interface 5 of each module 2 is configured for communication or data exchange with further modules 2. Typically, the module communication interface 5 of each module 2 is configured for communicating respectively exchanging data with each further module 2.

The shown master module 2.1 further includes a number of sensors 9 configured for providing a respective sensor signal in dependence of at least one environmental parameter. The master module 2.1 is configured to control the operation of the lighting elements 6 of at least one module 2 of the number of modules 2 in dependence of the number of sensor signals as explained in more detail in the general description.

The control unit 4 of each module 2 is a generally a semiconductor-based circuitry that typically includes one or more programmable components, such as microcontrollers, running a corresponding code, and/or dedicated circuitry as described in more detail in the general description. Further electronic components and modules, for example sensors 9, remote control device communication interface 2.1.3 and/or remote device communication interface 2.1.4 may be formed with the control unit 4 in a partly or fully integral manner.

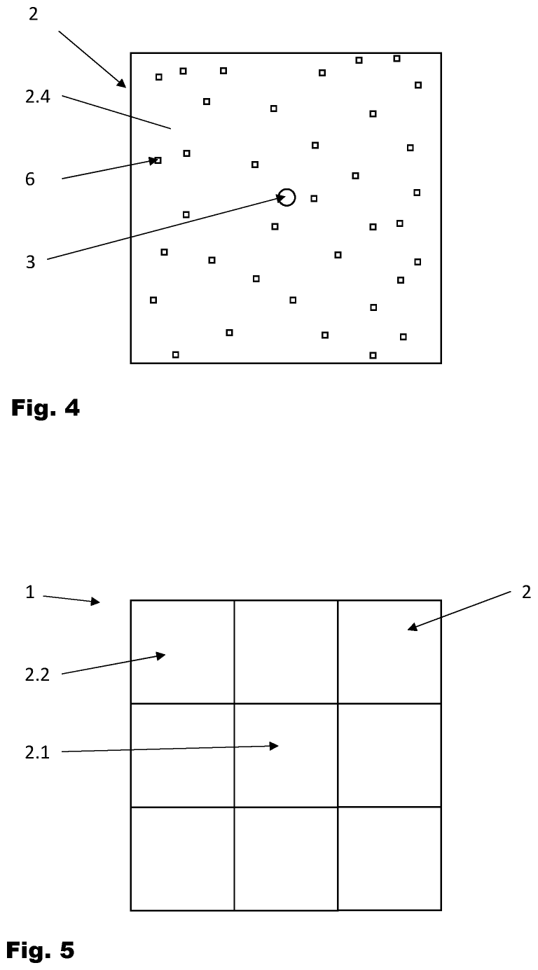

FIG. 4 shows a schematic front view of a module 2 which may either be a master module 2.1 or a slave module 2.2. The front surface 2.4 of the shown module 2 faces the room in which the lighting system 1 is installed or away from the wall or ceiling at which the module 2 is installed. The overall shape of the shown modules 2 is disk-shaped, with a thickness of the modules 2 in a typical range of 20 mm to 100 mm, while the footprint is square and has an edge length of, for example 500 mm. The lighting elements 6 of the shown module 2 includes a plurality of light emitting diodes (LEDs), favorably 4-color LEDs. The control unit 4 of each module 2 is generally configured to individually control the single lighting elements 6 and the single colors of each lighting element 6. A tubular mounting interface 3 is also visible in FIG. 4 for illustrative purposes, but is typically only visible and accessible after removal of the front wall of the module 2.

FIGS. 5-7 show different geometrical arrangements of the lighting system 1. FIG. 5 shows a squared arrangement of exemplarily nine modules 2. The modules 2 of the shown arrangement each have an identical footprint that enables them being arranged adjacent to each other, for example a 500 mm×500 mm footprint. The shown squared tessellation of modules 2 is favorable from a design and aesthetic point of view since it allows to arrange the modules such that the inner module is fully surrounded by adjacent modules 2. The shown arrangement of modules 2 forms an uninterrupted pattern and is advantageous to cover a wall or ceiling all-over. It is noted that the shown exemplary footprint is not essential. As already described in the general description other and more complex footprint geometries may also be used. Any one of the nine modules 2 may be a master module 2.1, while the other modules are slave modules 2.2.

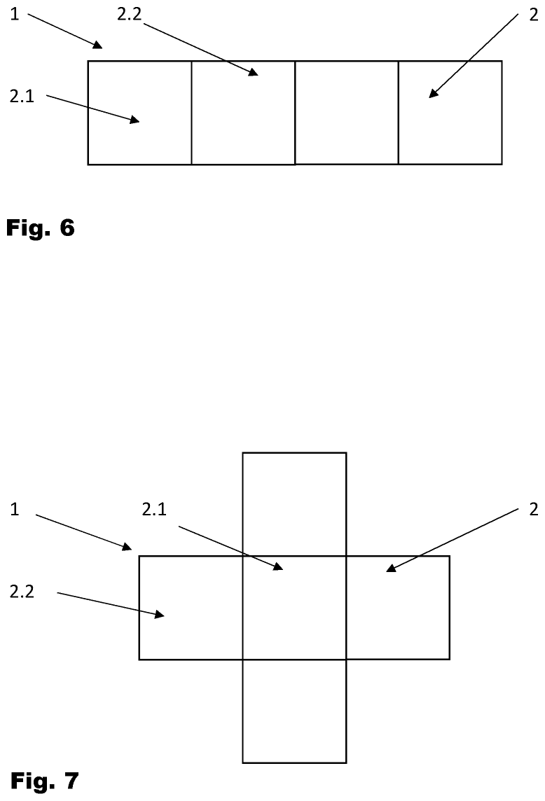

FIG. 6 shows an arrangement with a total number exemplarily four modules 2 that are arranged in a row respectively along a line. By way of example, the leftist module is the master module 2.1, while the other modules are slave modules 2.2. The master module 2.1, may however also have any other position as desired and/or required e.g. by the position of the external power supply. With an arrangement according to FIG. 6.

FIG. 7 shows a cross-shaped arrangement of one master module 2.1 and 4 adjacent slave modules 2.2. This arrangement is shown to demonstrate that the modules 2 do not have to be arranged as a square, rectangle or in line, but can be in theory arranged in any desired pattern. Further exemplarily, the master module 2.1 is shown in the center, but may be at any position as explained before.

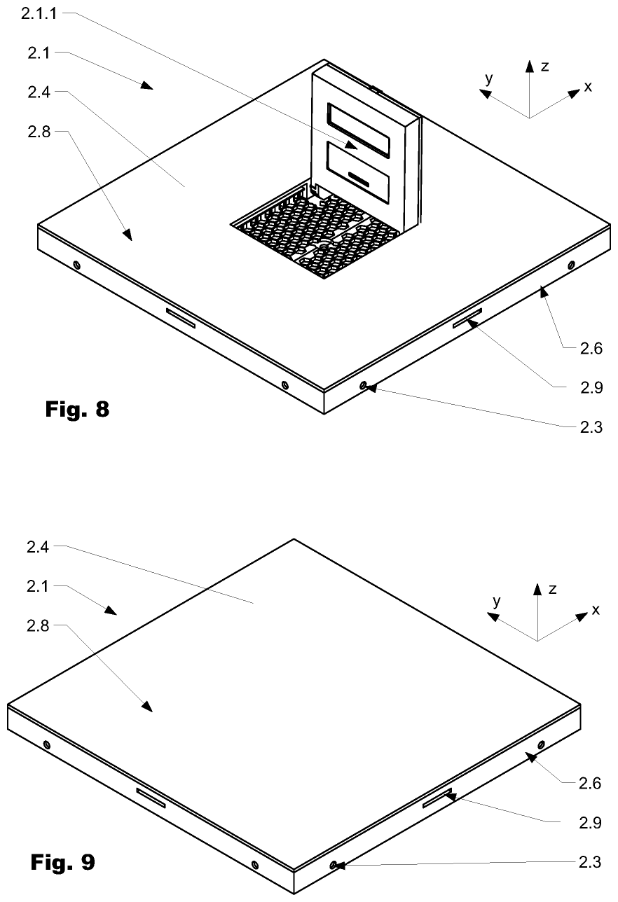

FIG. 8 shows an embodiment of a master module 2.1 with a local user interface 2.1.1 in the fold-out configuration. FIG. 9 shows the master module 2.1 with the local user interface 2.1.1 being in the fold-in configuration, also corresponding to a slave module 2.2. Apart from the local user interface 2.1.1, the following description for the master module 2.1 accordingly also refers to a slave module where no specific distinction is made.

The module is circumferentially limited by a frame 2.6. In the shown embodiment, the frame 2.6 is made of extruded profiles and includes module interconnection interfaces 2.3 to interconnect the modules 2 via bolts to one another. In alternative designs, the frame 2.6 may for example be manufactured by machining, e.g. milling, may be molded, punched, die-cut or the like. The frame 2.6 has exemplarily four segments that define the four sides of the module and form, in combination, the circumferential wall of the module. The shown master module 2.1 includes a number of power distribution interface connectors that are arranged at each side of the master module 2.1. For accessing the power distribution interface connectors, corresponding slits 2.9 are foreseen in the frame 2.6. For the slave modules, the power receiving interface connectors are arranged in the same manner and at the same position of the respective module. Where an electrical connection shall be established between the master module 2.1 and an adjacent slave module 2.2, a corresponding intermediate connector element may be coupled between the power distribution interfaces connectors and the power receiving interface connectors. The same applies to the electrical connection between power receiving interface connectors of adjacent slave modules. In embodiments where the module communication interfaces are wired interfaces with dedicated module communication interface connectors, such module communication interface connectors may be arranged in generally the same manner and may, for example be accessible via the same slits 2.9 or separately.

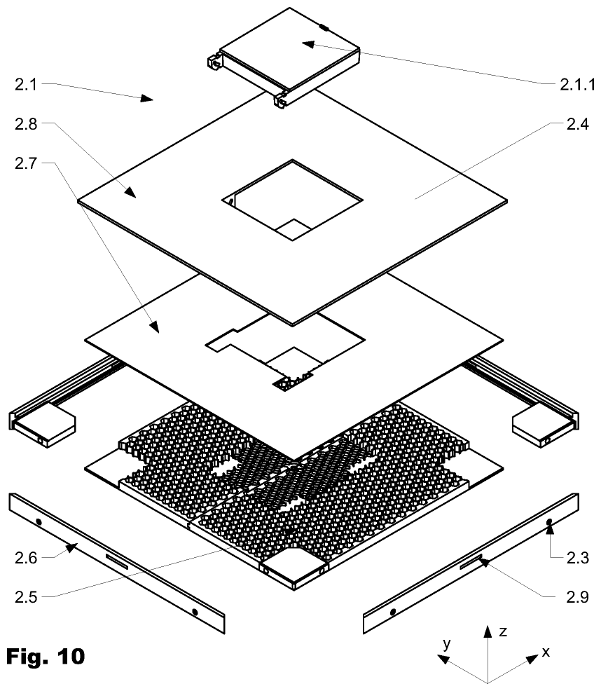

The frame 2.6 of each module is further configured to house the lighting elements carrier 2.7 (see FIG. 10) where the lighting elements are arranged thereon. Both modules 2 are covered by a front wall respectively front panel 2.8. In the shown embodiment the front wall 2.8 is made of a transparent material. The shown master module 2.1 includes a local user interface 2.1.1 that is arranged pivotable movably. The local user interface 2.1.1 projects from a front surface 2.4 of the master module 2.1 in the shown fold-out configuration (FIG. 8) and is flush with the front surface 2.4 of the master module 2.1 in the fold-in configuration (FIG. 9). In this configuration, the visible appearance of the master module 2.1 generally corresponds respectively is identical to a slave module.

FIG. 10 shows an exploded view of the master module 2.1 according to FIG. 8. The shown master module 2.1 is designed as a sandwich structure. In the shown embodiment the master module 2.1 includes a base plate 2.5 which is made of a lightweight building board. In the shown embodiment the base plate 2.5 is designed as a honeycomb structure. Alternatively, also cupboard, fiberboard or a combination of a thin board and thereon attached foam material or fabrics is also possible. The shown master module 2.1 is circumferentially limited by frame 2.6 which is in this embodiment made of extruded profiles. Alternatively, a frame 2.6 made of other materials, like sheet metal, composite or reinforced composites is also possible. The shown module interconnection interfaces 2.3 are configured to receive connection elements, in particular bolts, that are partly inserted into the module interconnection interfaces 2.3 and aligned with the module interconnection interfaces 2.3 of adjacent modules. In the shown embodiment, the front wall 2.8 2.8 is made of a transparent polymer. For example, glass, Plexiglas or other transparent materials are possible. The master module 2.1 is assembled with the help of a central connection element which is arranged in the mounting interface and interconnects the base plate 2.5, lighting elements carrier 2.7 and the cover plate 2.8 of the module 2 and also interconnects the whole module 2 to the wall or ceiling where it is mounted on. Apart from the local user interface 2.1.1, the design and exploded view of the slave modules 2.2 is generally identical.

### REFERENCE SIGNS

1 Lighting system
2 Module
2.1 Master module
2.1.1 Local user interface
2.1.2 Remote user interface
2.1.3 Remote control device communication interface
2.1.4 Remote device communication interface
2.2 Slave module
2.2.1 Power receiving interface
2.2.1.1 Power receiving interface connectors
2.3 Module interconnection interface
2.4 Front surface
2.5 Base plate
2.6 Frame
2.7 Lighting elements carrier
2.8 Front wall
2.9 Slit
3 Mounting interface
4 Control unit
5 Module communication interface
6 Lighting elements
7 Power supply unit
7.1 Power distribution interface
7.1.1 Power distribution interface connectors
7.1.2 Central mains adapter
7.2 Input supply connector
8 Separate local mains adapter
9 Sensors

1. A lighting system including a number of modules, the number of modules including a master module and a number of slave modules, wherein the modules each include:
a mounting interface for mounting the respective module on a wall or a ceiling,
a control unit, wherein the control unit is in each case configured to store a respective active lighting pattern of the respective module,
a module communication interface in operative coupling with the control unit of the respective module,
a plurality of lighting elements in operative coupling with the control unit of the respective module;
wherein the master module includes a power supply unit, wherein the power supply unit is configured to be connected to an external electric power supply, wherein the power supply unit further includes a power distribution interface, wherein the slave modules each include a power receiving interface configured to electrically connected to the power distribution interface,
wherein the master module is configured to generate a respective starting command for at least one module, and wherein each module is configured to autonomously execute the active lighting pattern of the respective module in response to the respective starting command, and
wherein the master module includes a local user interface in operative coupling with the control unit of the master module and/or the control unit of the master module is configured for operatively coupling with a remote user interface.

2. The lighting system according to claim 1, wherein the master module includes a local user interface that is arranged movably between a fold-out configuration and a fold-in configuration, wherein the local user interface projects from a front surface of the master module in the fold-out configuration and is flush with the front surface of the master module in the fold-in configuration.

3. The lighting system according to claim 1, wherein the master module includes a remote device communication interface, wherein the master module is configured to receive at least one lighting pattern via the remote device communication interface.

4. The lighting system according to claim 1, wherein the master module includes a number of sensors, wherein the sensors are each configured for providing a respective sensor signal in dependence of at least one environmental parameter, wherein the master module is configured to control operation the lighting elements of at least one module of the number of modules in dependence of the number of sensor signals.

5. The lighting system according to claim 1, wherein the modules are each configured to store a number of respective available lighting patterns, wherein the master module is configured to generate a respective selection command for each module, and wherein each module is configured to select either of the respective available lighting patterns as respective active lighting pattern in dependence of the respective selection command.

6. The lighting system according to claim 1, wherein the lighting system is configured for transmitting lighting patterns from the master module to the number of slave modules.

7. The lighting system according to claim 1, wherein each module is configured to store a respective unique module identifier and to transmit the respective unique module identifier to at least one further module of the number of modules.

8. The lighting system according to claim 1, wherein the control unit of the master module is configured to store an arrangement map, the arrangement map reflecting a position of each module with respect to each other module.

9. The lighting system according to claim 1, wherein the slave modules are each configured to generate a respective starting command for at least one further module.

10. The lighting system according to claim 1, wherein the modules each include a number of mechanical module interconnection interfaces, wherein the module interconnection interfaces are each configured to mechanically interconnect the respective module with an adjacent module.

11. The lighting system according to claim 1, wherein the modules each have a footprint that enables tessellation of a wall or ceiling by the number of modules.

12. The lighting system according to claim 11, wherein the modules each have a footprint corresponding to an equilateral triangle, a rectangle, a square, or a regular hexagon.

13. The lighting system according to claim 1, wherein the modules have in each case a substantially flat or planar front surface.

14. The lighting system according to claim 1, wherein the power distribution interface includes a number of power distribution interface connectors arranged at different sides of the master module, wherein the power distribution interface connectors are each configured for simultaneous coupling with the power receiving interface of a different respective slave module.

15. The lighting system according to claim 1, wherein the power receiving interface of at least a number of slave modules each include a number of power receiving interface connectors arranged at different sides of the respective slave module, wherein the power receiving interface connectors are each configured for alternative coupling with the power distribution interface, including a power distribution interface connector, or a power receiving interface connector of a further slave module.

16. A master module for use in the lighting system according to claim 1.

17. A slave module for use in the lighting system according to claim 1.

18. (canceled)
